(19) United States
(12) Patent Application Publication
(10) Pub. No.: US 2026/0303392 A1
(43) Pub. Date: Oct. 1, 2026

(54) MACHINE-LEARNING BASED METHOD FOR UTILIZING MACHINE LEARNING MODELS TO MONITOR AND CONTROL LEARNERS IN BREAKOUT ROOMS

(71) Applicants: Constructor Technology AG, Schaffhausen (CH); Constructor Education and Research Genossenschaft, Schaffhausen (CH)

(72) Inventors: Victor BATRAEV, Sofia (BG); Svetlana DERGACHEVA, Sofia (BG); Nikita ZHEREBTSOV, Sofia (BG); Alexander TORMASOV, Busingen am Hochrhein (DE); Laurent DEDENIS, Geneve (CH); Stanislav PROTASOV, Singapore (SG); Serg BELL, Singapore (SG); Nikolay DOBROVOLSKIY, Alanya (TR)

(21) Appl. No.: 19/084,849

(22) Filed: Mar. 20, 2025

(51) Int. Cl. H04L 12/18; G06V 20/40; G06V 40/20; G09B 5/14; H04L 65/403; G06V 10/764; G06V 10/766; G06V 10/82

(52) U.S. Cl. CPC H04L 12/1831; G06V 20/41; G06V 40/20; G09B 5/14; H04L 65/403; G06V 10/764; G06V 10/766; G06V 10/82

(57) ABSTRACT

Disclosed herein are systems and methods for machine-learning (ML)-based monitoring of learners in breakout rooms. The method includes: obtaining, for each learner in a plurality of breakout rooms, a plurality of video streams capturing each respective learner, a plurality of audio streams for each respective learner, and a plurality of capture streams capturing an interaction of each learner and a respective computing device; obtaining a list of predicted events indicative of success; monitoring activity in the plurality of breakout rooms by using a prepared monitoring MLM configured to generate an alert for a breakout room deviating from an assigned task; and generating an alert based on predicting that a breakout room is deviating from the assigned task based on outputs of the prepared monitoring MLM.

### FIELD OF TECHNOLOGY

The present disclosure relates to the field of machine learning, and, more specifically, to systems and methods for machine-learning based methods for training machine learning models (MLM) to generate a list of predicted events indicative of success for a group of learners in breakout rooms to complete a group task.

### BACKGROUND

Breakout rooms are a versatile tool used to facilitate group activities in educational, corporate, and social settings. By dividing participants into smaller groups, breakout rooms create an intimate and focused environment that encourages active engagement, collaboration, and meaningful discussions. This approach is particularly effective for activities that require problem-solving, brainstorming, or teamwork, as it allows participants to interact more freely and share diverse perspectives. Grouping participants thoughtfully—based on factors such as expertise, interests, or random allocation—can enhance the effectiveness of the activity, ensuring a balanced and dynamic interaction within each room. Breakout rooms also provide an opportunity for participants to build connections and work collectively toward a common goal, contributing to a richer overall experience.

Monitoring learner activity in breakout rooms presents a unique challenge, particularly when learners are engaged in completing a task or activity. For example, the decentralized nature of breakout rooms often limits an instructor or administrator’s ability to oversee all interactions effectively. In addition, instructors may face difficulties in ensuring equitable participation and addressing misunderstandings or groups going off task in real-time. Virtual platforms exacerbate these issues by requiring instructors to switch between breakout rooms, which provides only brief snapshots of group dynamics. Additionally, subtle indicators ofengagement, such as body language or side conversations, are often lost in virtual settings. These challenges can lead to discrepancies in learning outcomes, as some groups may deviate from the task or struggle without the necessary guidance. Consequently, monitoring breakout room activity demands a balance between fostering learner autonomy and providing timely support.

### SUMMARY

The present disclosure describes a system and method for training and utilizing a machine learning model (MLM) to generate a list of predicted events indicative of success for a group of learners within a breakout room to successfully complete a task. In this way, the present disclosure may provide data-driven insights by analyzing large volumes of historical data to identify patterns and correlations that may not be immediately evident to human observers, enabling a more objective understanding of success factors. In addition, the present disclosure offers real-time predictive analytics, allowing facilitators to intervene promptly if a group is off track, and support personalized interventions by recognizing group-specific patterns and suggesting tailored strategies. Additionally, the MLM may improve collaboration dynamics by highlighting indicators of effective teamwork, such as balanced participation and constructive feedback due to its ability to learn and refine predictions over time ensures continuous improvement.

In addition, the present disclosure also describes a system and method for monitoring participants in a group activity in breakout rooms to determine whether participants are deviating from the group activity. Training and utilizing a MLM to monitor participants in breakout rooms offers significant technical improvements and benefits, particularly in enhancing real-time monitoring and scalability. Unlike human observers, an MLM can analyze multiple breakout rooms simultaneously, processing data such as text, audio, and video to evaluate engagement, collaboration, and adherence to the activity’s objectives. Through techniques like natural language processing (NLP) and sentiment analysis, the model can detect deviations from the task, such as off-topic discussions or signs of disengagement, with greater precision and consistency than manual methods.

Furthermore, the MLM’s ability to identify early indicators of deviation, such as reduced interaction or prolonged silence, enables timely and targeted intervention by instructors. Real-time alerts generated by the MLM can prompt participants to refocus or notify educators of groups requiring attention, fostering a more efficient monitoring process. Additionally, the MLM can generate detailed reports on breakout room dynamics, offering valuable insights into engagement patterns and areas for improvement. These insights not only inform instructional design but also enable adaptive learning support by suggesting resources or guidance tailored to struggling groups. Importantly, modern MLMs can incorporate privacy-preserving methods, ensuring compliance with ethical standards while delivering meaningful monitoring outcomes. By automating this process, machine learning reduces the cognitive load on educators, enhances group activity outcomes, and provides a scalable solution for improving learner engagement in breakout rooms.

Other technical benefits of the present disclosure include the ability to utilize the MLMS to process large volumes of data—such as vocal tones, facial expressions, body language, and learner reactions—with a level of consistency and objectivity that human evaluators often cannot match. This ensures that feedback is more accurate and less influenced by subjective biases.

In one exemplary aspect, a method for machine-learning (ML)-based monitoring of learners in breakout rooms is disclosed. The method includes: obtaining, for each learner in a plurality of breakout rooms, a plurality of video streams capturing each respective learner, a plurality of audio streams for each respective learner, and a plurality of capture streams capturing an interaction of each learner and a respective computing device; obtaining a list of predicted events indicative of success for a type of activity assigned to the learners in the plurality of breakout rooms; monitoring activity in the plurality of breakout rooms by using a prepared monitoring MLM configured to generate an alert for a breakout room deviating from an assigned task based at least in part on analyzing the plurality of video streams, the plurality of audio streams, the plurality of capture streams, and the obtained list of the predicted events indicative of success for the type of activity; and generating an alert based on predicting that a breakout room is deviating from the assigned task based on outputs of the prepared monitoring MLM.

In some aspects, the techniques described herein relate to a method further including: obtaining the list of predicted events indicative of success for the type of activity on a timeline; and monitoring the activity in the plurality of breakout rooms by using the prepared monitoring MLM configured to generate the alert for a breakout room deviating from the type of activity based at least in part on analyzing the plurality of video streams, the plurality of audio streams, the plurality of capture streams, the obtained list of the predicted events indicative of success for the type of activity, and the timeline.

In some aspects, the techniques described herein relate to a method, wherein the predicted events correspond to at least one of: engagement events, task accomplishment events, and deviation events.

In some aspects, the techniques described herein relate to a method, wherein the type of activity comprises at least a type of task to be solved and a type of discussion for solving the task.

In some aspects, the techniques described herein relate to a method further including: obtaining lecture material corresponding to the plurality of breakout rooms and an expected result of the type of activity; and determining the type of activity based on the lecture material using a Large Language Model (LLM).

In some aspects, the techniques described herein relate to a method further including: preparing the monitoring MLM by: (1) providing, to the monitoring MLM, a monitoring training dataset comprising at least one of: (a) a plurality of training video stream data labeled and annotated to identify task engagement features and task deviation features, (b) a plurality of training audio stream data labeled and annotated to identify task-oriented speech and off-task speech, (c) capture stream data labeled and annotated to identify on-task activity and off-task activity, and (d) ground truth labels for the plurality of training video stream data, the plurality of training audio stream data, or the capture stream data to serve as a target output for the monitoring MLM; and (2) preparing the monitoring MLM using the monitoring training dataset.

In some aspects, the techniques described herein relate to a method, wherein the prepared monitoring MLM comprises one or more of: a classification model, a regression classification model, an autoencoder neural network, a neural network model, or an LLM.

In some aspects, the techniques described herein relate to a method, wherein the breakout rooms correspond to virtual breakout rooms.

In some aspects, the techniques described herein relate to a method, further comprising: analyzing interactions between the learners within a group of each breakout room for predicting successful behavior patterns for the type of activity using a prepared prediction machine learning model (MLM) configured to predict events indicative of success for the type of activity based on the obtained lecture material, the type of activity, and the result; and generating the alert based on predicting that a breakout room is deviating from the assigned task based on outputs of the prepared monitoring MLM and the prepared MLM.

According to one aspect of the disclosure, a system is provided for machine-learning (ML)-based monitoring of learners in breakout rooms, the system including: at least one memory; and at least one hardware processor coupled with the at least one memory and configured, individually or in combination, to: obtain, for each learner in a plurality of breakout rooms, a plurality of video streams capturing each respective learner, a plurality of audio streams for each respective learner, and a plurality of capture streams capturing an interaction of each learner and a respective computing device; obtain a list of predicted events indicative of success for a type of activity assigned to the learners in the plurality of breakout rooms; monitor activity in the plurality of breakout rooms by using a prepared monitoring MLM configured to generate an alert for a breakout room deviating from an assigned task based at least in part on analyzing the plurality of video streams, the plurality of audio streams, the plurality of capture streams, and the obtained list of the predicted events indicative of success for the type of activity; and generate an alert based on predicting that a breakout room is deviating from the assigned task based on outputs of the prepared monitoring MLM.

In one exemplary aspect, a non-transitory computer-readable medium is provided storing a set of instructions thereon for machine-learning (ML)-based monitoring of learners in breakout rooms, the system, including instructions for: obtaining, for each learner in a plurality of breakout rooms, a plurality of video streams capturing each respective learner, a plurality of audio streams for each respective learner, and a plurality of capture streams capturing an interaction of each learner and a respective computing device; obtaining a list of predicted events indicative of success for a type of activity assigned to the learners in the plurality of breakout rooms; monitoring activity in the plurality of breakout rooms by using a prepared monitoring MLM configured to generate an alert for a breakout room deviating from an assigned task based at least in part on analyzing the plurality of video streams, the plurality of audio streams, the plurality of capture streams, and the obtained list of the predicted events indicative of success for the type of activity; and generating an alert based on predicting that a breakout room is deviating from the assigned task based on outputs of the prepared monitoring MLM.

The above simplified summary of example aspects serves to provide a basic understanding of the present disclosure. This summary is not an extensive overview of all contemplated aspects and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for training and utilizing MLMs to monitor learners working together to complete an activity in breakout rooms according to aspects of the present disclosure.

FIG. 2 is a block diagram illustrating a system for preparing machine learning models to predict events for a successful activity completion and monitor learners in a breakout room according to aspects of the present disclosure.

FIG. 3 is an example flowchart for preparing a MLM to predict events involved in a completing an activity according to aspects of the present disclosure.

FIG. 4 is an example flowchart for preparing a MLM to predict successful behavior pattern according to aspects of the present disclosure.

FIG. 5 is an example flowchart for utilizing a MLM to monitor learners in a breakout room according to aspects of the present disclosure.

FIG. 6 an example of a user interface for monitoring learners in a breakout room including generating alerts when learners are predicted to be off track according to aspects of the present disclosure.

FIG. 7 is an example method for preparing a MLM to predict events involved in a completing an activity according to aspects of the present disclosure.

FIG. 8 is an example method for utilizing a MLM to generate an alert by predicting that learners in a breakout room are deviating from predicted successful behavior pattern according to aspects of the present disclosure.

FIG. 9 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for preparing and utilizing a machine learning model (MLM) for predicting a successful behavior pattern for learners in a breakout room to complete an activity and a MLM for monitoring learners in virtual breakout rooms. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

Machine learning (ML) has increasingly been leveraged to analyze and predict behavior patterns in collaborative learning environments, such as breakout rooms. These smaller, focused group settings are integral to active learning strategies, encouraging participants to collaborate and complete tasks that enhance comprehension and critical thinking. By analyzing data on learner interactions and behavior, ML can help identify successful patterns that lead to effective collaboration and task completion.

MLMs rely on diverse data sources, including interaction logs, communication patterns, task completion times, and sentiment analysis of text or speech. For example, features like the frequency of contributions, equitable participation, and responsiveness in discussions can indicate successful collaboration. Advanced ML algorithms can identify subtle trends in these behaviors, distinguishing between patterns that lead to productive outcomes and those that do not. Through supervised learning approaches, labeled datasets of successful and unsuccessful breakout room interactions can train models to recognize effective behavior patterns. Unsupervised methods, like clustering, can uncover novel patterns in learner interactions that might contribute to success. Once trained, these models can provide real-time feedback or suggest interventions, such as redistributing roles or encouraging more balanced participation, to foster productive group dynamics.

The predictive power of ML in this context allows educators and facilitators to optimize breakout room activities. By understanding what contributes to success, instructors can design better group tasks, provide tailored guidance, and even use real-time analytics to improve group performance during activities. Ultimately, ML enhances the ability to create engaging, equitable, and effective collaborative learning experiences. Additionally, ML enables real-time assessment. It can identify when participants appear to not be exhibiting successful behavior patterns for a type of activity, allowing for an educator or administrator to check in on the breakout room.

Finally, the scalability and efficiency of machine-learning methods allow them to be used repeatedly and on a larger scale without additional manual effort. Over time, as more data is collected, the system improves in accuracy and nuance, continuously providing actionable insights. This leads to more accurate predictions of events for successful behavior patterns, and ultimately more control and monitoring of each breakout group.

Accordingly, the present disclosure assesses the interaction and behavior of learners in a breakout room to monitor and control their activities in the breakout rooms. One aspect involves training a MLM to predict common events that occur in the breakout rooms when the group of learners successfully complete an activity. A second aspect involves determining a type of activity to be performed in the breakout room. A third aspect involves recognizing events from successful breakout rooms based on a video stream, audio stream, and capture inputs of learners during their successful breakout room sessions. A fourth aspect involves training the MLM to predict successful behavior pattern based on new (e.g., unknown) lecture material. A fifth aspect involves monitoring the breakout rooms such that an alert may be generated when a particular breakout room is predicted to deviate from the successful behavior pattern. Turning now to the figures, example aspects are depicted with reference to one or more components described herein, where components in dashed lines may be optional.

It should be noted that although the present disclosure will describe breakout rooms in the context of education for group discussions, peer reviews, or project-based learning, those of ordinary skill in the art will understand that the present disclosure may apply to any types or uses of breakout rooms. For example, the breakout room may be used in corporate training to facilitate role-playing exercises, brainstorming sessions, or skill workshops. In professional team environments, they support focused discussions, agile sprint planning, and sub-team meetings, ensuring efficient collaboration on specific tasks. Accordingly, breakout rooms may cater to diverse needs, creating an interactive and productive environment in various contexts.

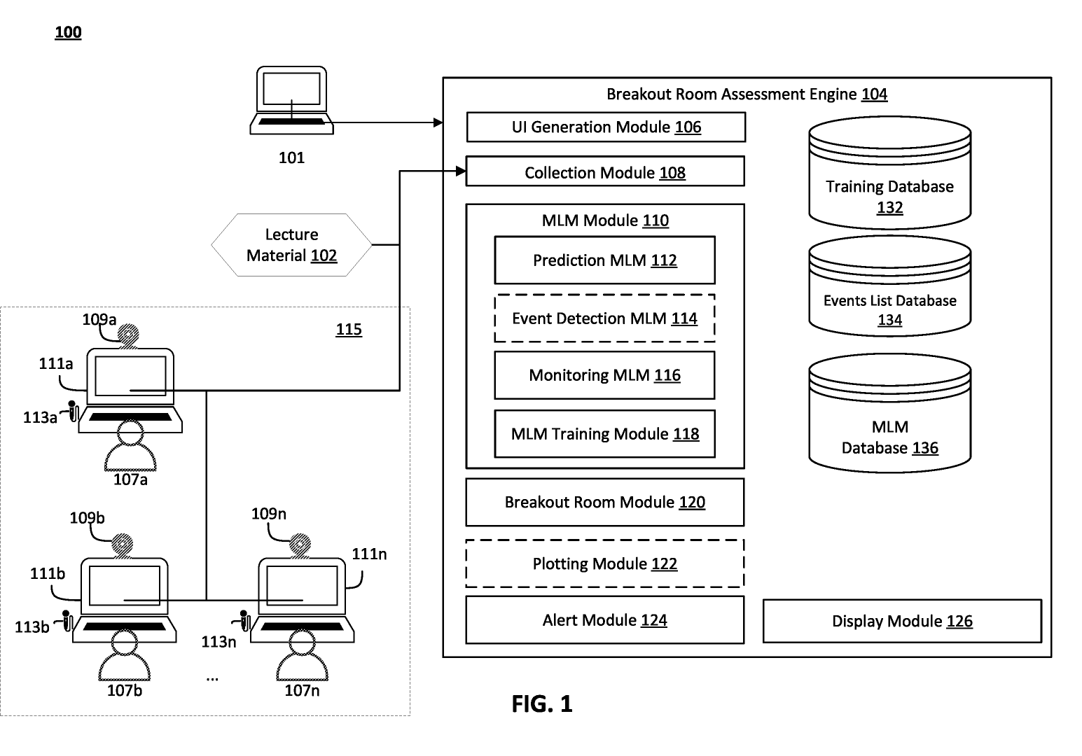

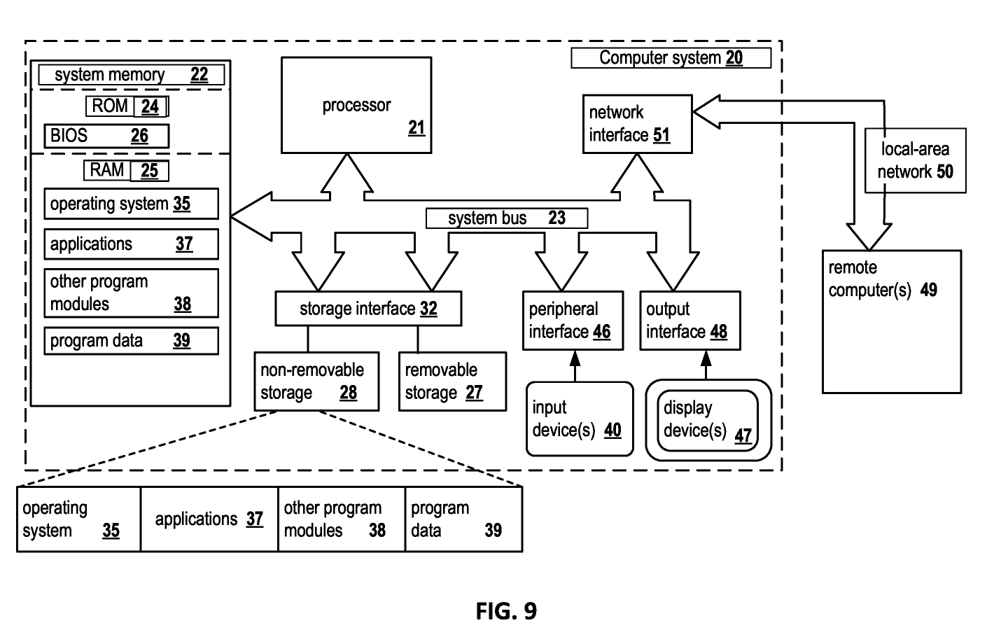

FIG. 1 is a block diagram illustrating a system 100 configured to train and utilize MLMs to generate a task list for monitoring learners in breakout rooms and to monitor the learners working together to complete an activity in breakout rooms. In one aspect, the components of system 100 may be implemented on computer systems, such as that shown in FIG. 9.

The system 100 may be used to assess and monitor behavior of learners tasked with completing an activity in breakout rooms. The breakout room assessment engine 104 is configured to predict successful behavior patterns involved with similar types of activities to create a “rubric” for the activity. In addition, the breakout room assessment engine 104 is configured to detect events from the breakout rooms based on analyzing video stream data, audio stream data, and capture inputs capturing the learners in the breakout room. Furthermore,the breakout room assessment engine 104 is configured to predict whether the learners are deviating from the predicted successful behavior pattern for the determined type of activity. In this way, the breakout room assessment engine 104 can quickly analyze data from dozens of cameras, microphones, and screen captures such as vocal tones, facial expressions, body language, and audience member reactions and generate real-time feedback on whether the learners are diligently working on their activity or deviating from the activity.

The system 100 includes at least lecture material 102, at least one group of learners 107a, 107b, 107n assigned to a breakout group 115 including at least cameras 109a, 109b, 109n, microphones 113a, 113b, 113n, and screen captures 111a, 111b, 111n for a respective learner, and a breakout room assessment engine 104. The computing device 101 may execute a plurality of modules in the breakout room assessment engine 104 that together make up the collection, analysis, identification, and prediction system. In some aspects, the breakout room assessment engine 104 may correspond to the computing device 101 or cloud network (not shown) that is configured to execute a plurality of modules that together make up the breakout room assessment engine 104 for monitoring the learners 107a, 107b, 107n in the breakout room. It should be noted that although only three learners 107a, 107b, 107n, and one breakout group 115 are illustrated in FIG. 1, the present disclosure it not limited to only three learners per breakout group or only one breakout group. Those of ordinary skill in the art will recognize that the present disclosure can apply to any number of breakout groups that consist of any number of learners.

In some aspects, the breakout room assessment engine 104 may include a user interface (UI) generation module 106, a collection module 108, a MLM module 110 including at least a prediction MLM 112, an optional event detection MLM 114, a monitoring MLM 116, and a MLM training module 118, a breakout room module 120, an optional plotting module 122, an alert module 124, a display module 126, a training database 132, events list database 134, and a MLM database 136.

The computing device 101 may execute a UI generation module 106 to implement a UI for display on the computing devices 101, 111a, 111b, 111n that is configured to receive input from the respective computing devices and administer the breakout room. In particular, the computing device 101 for the administrator may display a UI that allows the administrator to view alerts for breakout rooms that are deviating from the assigned task and/or join a specific breakout room.

In some aspects, the UI generation module 106 generates a single UI for an administrator on the computing device 101 and layout and components of the UI elements (e.g., menus, buttons, forms, grids, etc.) based on predefined rules, data models, or templates. In some aspects, the UI generation module 106 may also be configured to automatically adjust the UI elements based on the content or data that it needs to display such as adapting a form to input fields or displaying a list of items. In some aspects, the UI generation module 106 may also be configured to adapt the UI to different screen sizes and resolutions by making sure that the UI works well across various devices.

The computing device 101 may execute a collection module 108 that collects and obtains lecture material 102, data streams from the cameras 109a, 109b, 109n, audio streams from the microphones 113a, 113b, 113n, and screen captures of the computing devices 111a, 111b, 111n to monitor the learners in the breakout rooms and generate alerts. In some aspects, portions of the lecture material 102 may be stored on a training database 132. In some aspects, data from the cameras 109a, 109b, 109n, microphones 113a, 113b, 113n, and screen captures of the computing devices 111a, 111b, 111n may be stored in the events list database 134. In some aspects, the prepared prediction MLM 112, the optional event detection MLM 114, and/or the monitoring MLM 116 may be stored on a MLM database 136.In some aspects, the training database 132, the events database 134, and the MLM database 136 may be stored on a local device such as the computing device 101 or a cloud network.

In some aspects, lecture material 102 may be obtained by the collection module 108. The lecture material 102 may include at least presentation slides, lecture notes, speaking notes, readings and references, multimedia content, case studies and examples, exercise and practice questions, diagrams and chats, discussion prompts, or supplementary resources. The lecture material 102 serves as a guide to the core concepts and topics covered in the presentation. In some aspects, the lecture material 102 may include information regarding an activity and/or type of activity to be performed by the breakout rooms and expected results and/or goals/objectives of the activity.

The computing device 101 may execute a MLM module 110 including at least a prediction MLM 112, an optional event detection MLM 114, a monitoring MLM 116, and a MLM training module 118. The MLMs in the MLM module 110 may correspond to a large language model (LLM). It should be noted that LLMs are described in this present disclosure for illustrative purposes only and that any suitable MLM may be utilized to perform the particular specific tasks of the prediction MLM 112, an optional event detection MLM 114, and a monitoring MLM 116.

A LLM is an advanced artificial intelligence system designed to understand and generate human-like text. These models are trained on vast amounts of data, enabling them to comprehend context, recognize patterns, and produce coherent and contextually relevant responses. LLMs are utilized in various applications, including chatbots, content creation, and language translation. Their ability to process and generate natural language makes them powerful tools for enhancing communication and automating tasks that require language understanding. However, the LLM modules must first go through preparing (e.g., training, retraining, distillation, fine-tuning, etc.) to teach each LLM model to perform their respective specific tasks. As a nonlimiting example, the LLM models may incorporate one of the machine learning models listed below.

A transformer is a deep learning architecture used in LLMs. The transformer has an encoder/decoder structure with numerous stacked multi-head attention layers and feed forward network layers. This architecture allows the model to process and generate text effectively, capturing long-range dependencies and contextual information. Transformers are well-suited for tasks like natural language processing, and image classification and generation. Common examples of transformer models are generative pre-trained transformer (GPT) and Bidirectional Encoder Representations from Transformers (BERT).

A classification model is a type of machine learning model that is designed to predict the category or class to which a given data point belongs to. The classification model works by analyzing input features and assigning them to one of several predefined labels. These models are trained on labeled data, where the correct category is known, and they learn patterns that allow them to make predictions on new, unseen data. Examples of classification models include at least a regression model used for binary classification, a decision tree used to predict class by splitting data based on feature values, support vector machine (SVM) configured to perform classification by finding the best boundary between classes, and neural networks.

In some examples, a prepared prediction MLM 112 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by the prediction MLM may be one of the following: transformer neural network, convolution neural network (CNN), recurrent neural network (RNN), long short-term memory (LSTM) network, gated recurrent unit (GRU) network, autoencoder, generative adversarial network (GAN).

An autoencoder is a type of neural network used for unsupervised learning and dimensionality reduction and consists of an encoder that compresses input data into a lower-dimensional representation (encoding) and a decoder that reconstructs the original input from the encoding.

For analysis and prediction tasks such as predicting events involved in a successful breakout room, an untrained prediction MLM 112 will first analyze data from a training set to “learn” and recognize events that commonly occur in successful breakout rooms. As an example, the training dataset may include at least: (a) a plurality of training lecture material data comprising at least lecture material, a type of activity to be performed and the expected result of the type of activity, wherein the plurality of training lecture material data is labeled and annotated to identify a type of activity; (b) interaction data annotated and labeled to assess communication features, collaboration metrics, or emotional and sentiment features; (c) activity data annotated and labeled to classify the types of activities performed in breakout rooms and associate activity types with specific lecture topics or objectives; (d) performance and outcome data annotated and labeled with outcome metrics and success indicators; and (e) ground truth labels for the plurality of training lecture material data, the interaction data, the activity data, or the performance and outcome data to serve as a target output for the prediction MLM model. The ground truth labels may include at least success labels identifying successful and unsuccessful behavior patterns in the breakout rooms, behavior patterns identifying specific behaviors, or event labels identifying events indicative of success or failure.

During training of the prediction MLM 112, the results from the untrained MLM are then compared with known data set results using the corresponding labels identifying events from successful breakout rooms for a variety of different types of activities. It should be noted that the input to the trained prediction MLM 112 will be data from the training dataset.

For every input training sample from the training dataset, the trained MLM in the prediction MLM 112 will produce a prediction consisting of values representing a probability that a detected event is indicative as successful or not successful based on the video streams, audio streams, and/or screen captures of the respective computing devices of the learners. The output with the highest probability determines the classification of the event as successful, neutral, or not successful.

In addition, a class label for each answer may be used to compute a loss (e.g., loss function). Specifically, a loss function generator (not pictured) in the MLM training module 118 may obtain, for each breakout room that successfully performed an assigned task for the type of activity in the breakout room, the plurality of video streams capturing each respective learner, the plurality of audio streams for each respective learner, and the plurality of capture streams capturing an interaction of each learner and a respective computing device. The loss function generator may also identify events from the plurality of video streams, the plurality of audio streams, and the plurality of capture streams; generate a list of events indicating success based on the identified events; compute a loss value by measuring a delta between the generated list of the predicted events and the identified events indicative of success; and adjust one or more parameters of the prediction MLM based on the computed loss value.

For example, the trained prediction MLM 112 uses the loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal. In some examples, an appropriate loss function, such as Mean Squared Error (MSE) for regression tasks or a Cross-Entropy Loss for classification tasks.

Once the MLM is trained (e.g., inference), the trained prediction MLM 112 may predict events indicative of success for an activity (e.g., or type of activity).

During inference, the trained prediction MLM 112 does not re-evaluate or adjust the layers of the neural network based on the results. Instead, the inference applies knowledge from the trained neural network and uses it to infer a result. Accordingly, when a new unknown dataset (e.g., new lecture material) is input through the prepared prediction MLM 112, the trained MLM outputs a score evaluating whether detected events are predicative of success, neutral, or failure (e.g., off track) based on predictive accuracy of the MLM.

Similarly, during preparation (e.g., training) of the optional event detection MLM 114, the events training set comprising of a sequence of frames containing an action performed by a person and an event label identifying the action in the sequence of frames of the video. It should be noted that the input to the optional event detection MLM 114 will be data from the training dataset.

In some aspects, the individual video streams, corresponding audio streams, and/or capture streams may be obtained and stored on an events database 134 such that the data from each stream is indicative of engagement. As a non-limiting example, the events that may be detected or identified may include at least one of: facial expressions (e.g., smiling, nodding, or raising eyebrows as a sign of agreement, interest, or curiosity for engagement), eye contact (e.g., maintaining eye contact with the presenter or the visual aids or avoiding signs of distraction, such as frequently looking at phones, watches, or around the room), posture (e.g., leaning forward as a sign of interest and attentiveness or sitting upright, as opposed to slouching or reclining, which may indicate disengagement), gestures and movements (e.g., nodding in agreement or making thoughtful gestures or limited fidgeting, restlessness, or other signs of distraction), participation (e.g., actively asking questions, responding to prompts, or interacting with the presenter or engaging in discussions or showing enthusiasm during group activities), verbal cues (e.g., providing thoughtful and relevant answers to questions posed by the presenter, making comments or contributions that reflect understanding and attention, or expressive and engaged tones when speaking, rather than monotone or hesitant replies), behavioral interaction with tools or aids (e.g., engagement with provided tools, such as polls, quizzes, or note-taking applications), or social interaction (e.g., collaborative engagement with other audience members during group activities or discussions).

For every input training sample from the training dataset, the optional trained event detection MLM 114 will produce a prediction consisting of values representing a probability corresponding to identification of an event based on the video streams from the cameras 109a, 109b, 109n, the audio stream from the microphones 113a, 113b, and 113n, and the capture screens of the devices 111a, 111b, 111n. The output with the highest probability determines the identification and/or classification of the event.

Similar to the trained prediction MLM 112, the trained MLM from the optional event detection MLM 114 then uses a loss function that quantifies the error between the predicted output and the ground truth for a given training sample. In other words, the loss function can be used to guide the learning process by updating the network weights in a way that improves the accuracy of future predictions. This process may continue until the difference between the prediction and the correct targets is minimal.

During inference, the trained event detection MLM 114 does not re-evaluate or adjust the layers of the MLM based on the results. Instead, the inference applies knowledge from the trained MLM and uses it to generate an evaluation (e.g., engagement score) and engagement feedback. Accordingly, when a new unknown dataset (e.g., new video data streams, new audio streams, and/or new screen captures) is input through the trained event detection MLM 114, the trained MLM outputs a prediction of the identification and/or classification of the event based on the video streams from the cameras 109a, 109b, 109n, the audio stream from the microphones 113a, 113b, and 113n, and the capture screens of the devices 111a, 111b, 111n.

During training of the monitoring MLM 116, the topic training dataset will include: (a) a plurality of training video stream data labeled and annotated to identify task engagement features and task deviation features; (b) a plurality of training audio stream data labeled and annotated to identify task-oriented speech and off-task speech; (c) capture stream data labeled and annotated to identify on-task activity and off-task activity; (d) ground truth labels for the plurality of training video stream data, the plurality of training audio stream data, or the capture stream data to serve as a target output for the monitoring MLM 116.

In some aspects, an optimizer such as Adam or SGD may be used to train the models in the prediction MLM 112, the optional event detection MLM 114, and the monitoring MLM 116. In some aspects, the data may be split into training, validation, and test sets. In these aspects, the MLMs from the prediction MLM 112, the optional event detection MLM 114, and the monitoring MLM 116 are trained on the training dataset and then validated by the validation sets in order to tune hyperparameters.

The computing device 101 may execute a breakout room module 120 configured to facilitate smaller group discussions or activities within a larger virtual meeting. The breakout room module 120 may be configured to allow the administrator (e.g., host) to create, manage, dissolve, and/or join multiple breakout rooms within a single session. In addition, the breakout room module 120 may provide the administrator with oversight and control over breakout room activities. For example, this may include the ability to join and monitor breakout rooms, broadcast messages or announcements to all breakout rooms, and /or end breakout sessions and recall participants to the main room. In some aspects, the breakout room module 120 may also support virtual group activities by including access to collaborative whiteboards or shared notes, polls or quizzes for group interaction, and/or templates or prompts to guide discussions.

The computing device 101 may execute an optional plotting module 122 configured to plot predicted events indicative of success for a particular activity or type of activity for a group of leaners within a breakout room on a timeline. For example, the optional plotting module 122 is configured to visualize predicted events that signal success for a specific activity or type of activity undertaken by a group of learners within the breakout room. This module may plot these events on a timeline, providing a chronological representation of key milestones or performance indicators. The timeline serves as a dynamic tool to track progress, anticipate outcomes, and alert the administrator to intervene with the group in real-time. By contextualizing predicted events within a temporal framework, the administrator may identify patterns, optimize intervention timing, and enhance the overall effectiveness of the learning experience.

The computing device 101 may execute an alert module 124 configured to generate an alert based on predicting that a particular breakout room is deviating from the assigned task based on outputs of the prepared monitoring MLM. This module works in conjunction with the prepared MLMs in the MLM module 110 to continuously evaluates leaners’ interactions and activities against the expected task parameters, detecting anomalies or distractions. The significance of this functionality lies in its ability to provide real-time feedback, allowing administrators to promptly intervene and redirect focus. By ensuring alignment with objectives, this feature enhances productivity, maintains engagement, and supports the successful completion of assigned tasks.

The computing device 101 may execute a display module 126. The display module 126 may be configured to generate and display the video streams of the learners during the breakout room sessions. Generally, the display module 126 is responsible for managing and rendering the visual components of the user interface by handling the presentation of information to the user, ensuring that data and controls are displayed correctly and consistently across the UI.

In some aspects, the display module 126 is configured to render or draw all the elements of the UI, such as windows, buttons, text fields, menus, icons, images, and other components. In some aspects, the display module 126 is configured out update the UI when the data changes or user interactions occur (e.g., clicking a button or typing in a text box) such that the display module updates the UI accordingly. This could mean refreshing a portion of the screen, changing the state of a button, or displaying new data. In other words, the display module 126 may be considered the “view” part of a model-view-controller (MVC) or similar design pattern. It serves as the layer that presents data to the user and receives input to and from the computing devices 101, 111a, 111b, 111n.

It should be noted that although the analysis, training, event detection, and real-time monitoring described in the present disclosure are heavily simplified. One skilled in the art will appreciate that the MLMs utilized may have significantly large datasets with highly specific details. For example, MLMs may analyze large volumes of historical data to identify patterns and correlations that may not be evident to human observers. Features indicating successful completion of a task or type of task by learners in a virtual breakout room can include metrics such as active participation through consistent audio or text contributions, the frequency and depth of collaborative exchanges, alignment of discussions with assigned objectives, and timely completion of predicted tasks for completing the activity. Other indicators may involve sentiment analysis, showing positive engagement or constructive interactions, and the utilization of shared resources like collaborative whiteboards or documents. MLM can even assess language patterns for problem-solving behaviors or conflict resolution. This type of analysis far exceeds the capabilities of the human mind or traditional pen-and-paper methods due to the sheer volume, complexity, and speed of data processing required. Humans cannot simultaneously monitor multiple breakout rooms, analyze nuanced patterns in real-time, or provide immediate insights based on multi-dimensional data streams. Automated tools not only offer precision and scalability but also uncover trends and correlations that would be imperceptible to manual observation, enabling a more informed and effective approach to facilitating learning and collaboration.

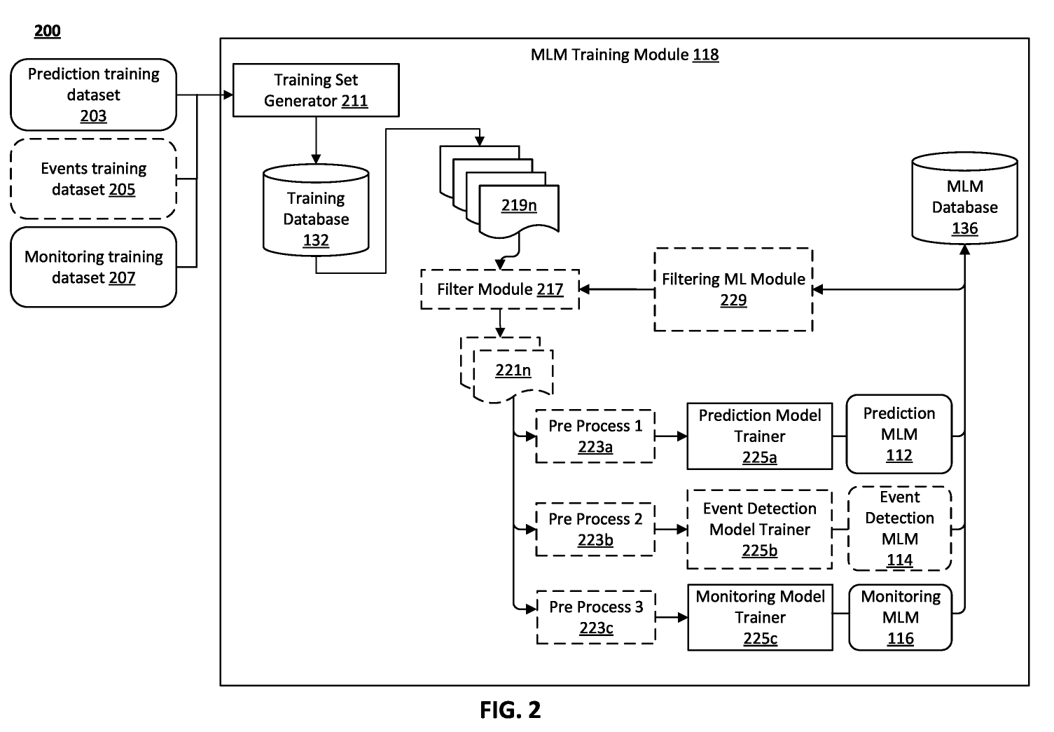

FIG. 2 is a block diagram illustrating a system for preparing machine learning models to predict events for a successful activity completion and monitor learners in a breakout room according to aspects of the present disclosure. As shown in example 200, the MLM training module 118 is configured to build and train specialized machine learning models with inference to perform particular tasks. This enables the specialized machine learning models to develop an ability to perform particular objectives on inputs that are not part of a training dataset. By subjecting the specialized MLMs to large amounts of unlabeled and/or labeled training data sets, the specialized MLMs may perform particular tasks such as predicting events involved in completion of an activity, identifying and detecting events from a video data stream, corresponding audio stream, and capture input for the learners in the breakout rooms, and monitoring activity of learners in the breakout rooms to predict if learners are deviating from predicted successful behavior patterns.

Supervised learning is effective for tasks such as classification (assigning inputs to predefined categories) and regression (predicting continuous values) since it relies on the availability of labeled data for both training and evaluation phases. In supervised learning, the MLM training module 118 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the MLM training module 118 provides the algorithm with a training dataset including input-output pairs. The algorithm learns the mapping function that relates inputs to outputs through an iterative process, adjusting its internal parameters based on the provided examples.

During model building, the algorithm creates a model that can generalize from the training data to make predictions on new, unseen data. The model's complexity varies based on the algorithm used. For example, the model may be a simple linear regression model or a complex neural network. During the prediction phase, the MLM training module 118 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

In some aspects, the MLM training module 118 includes at least a training database 132 configured to store the raw training data 219n and corresponding labels, a MLM database 136 to store the trained models (e.g., the prepared prediction MLM 112, the optional event detection MLM 114, and the monitoring MLM 116). In some aspects, the MLM training module 118 may include an optional filtering machine learning model 229 and an optional filter module 217 configured to filter data from the training database 132 for training by removing poorly generated training data.

Training data from the prediction training dataset 203, optional events training dataset 205, and monitoring training dataset 207 is received into the MLM training module 118 via the training set generator 211. Details about the data included in each training dataset is described in more detail above with FIG. 1.

An optional filter module 229 is configured to filter out bad training images and/or data to clean up the training data in the training dataset 219n. In some examples, the optional filter module 217 may be a neural network. In some examples, the optional filter module 217 is a mathematical model. In some examples, the cleaned training dataset 221n then undergoes optional preprocessing steps depending on which neural network or model is being trained.

The optional preprocess 1 223a, preprocess 2 223b, and preprocess 3 223c are automated processes that modify the raw data received from 219n (or cleaned training dataset 221n) and prepare the raw data as input to the respective model trainers (e.g., prediction model trainer 225a, the optional event detection model trainer 225b, or monitoring model trainer 225c). These may be described in the MLM training module 118 as snippets of code that prepares the datasets. In some examples, the preprocessing module (e.g., preprocess 1 223a, preprocess 2 223b, and preprocess 3 223c) for a particular trainer may be an automated script or code that will be setup the first time any model is trained.

The prediction model trainer 225a, the optional event detection model trainer 225b, or monitoring model trainer 225c are the scripts or code that train the respective models. The prediction model trainer 225a, the optional event detection model trainer 225b, or monitoring model trainer 225c may be a script or code that holds the instructions on how a model should be trained (e.g., optimization method, model architecture, dataset division, etc.) and also runs the training. The prediction model trainer 225a, the optional event detection model trainer 225b, or monitoring model trainer 225c each take as input the raw or filtered processed training data and train the prediction model trainer 225a, the optional event detection model trainer 225b, or monitoring model trainer 225c to achieve their specific objectives, respectively.

In summary, the raw dataset 219 or cleaned dataset 221n may optionally go through different preprocessing steps 223a, 223b, 223c and then a corresponding presentation prediction model trainer 225a, optional event detection model trainer 225b, or monitoring model trainer 225c to generate a prepared prediction MLM 112, an optional prepared event detection MLM 114, or a prepared monitoring MLM 116. In some examples, each of these models may be a MLM or a neural network.

As a non-limiting example and as discussed above, the machine learning may be a neural network. The neural network models are designed using a set of hyperparameters that define high-level aspects of their architecture and training process. These hyperparameters include but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 219n used for training may include noise and bad training images from the training database 132. Accordingly, to create a clean and filtered training dataset, the optional filter module 217 is configured to filter out unwanted data points from the raw training dataset 219n by developing smaller, less accurate systems based on patterns and metadata information.

During the training process, the prediction model trainer 225a, the optional event detection model trainer 225b, or the monitoring model trainer 225c are presented with input data and labels of actual values, and the optimization objective, which aims to minimize the difference between the actual value and the predicted value, is calculated. The optimization algorithm updates the parameters of the prediction model trainer 225a, the optional event detection model trainer 225b, or the monitoring model trainer 225c to reduce the value of the objective. This process is repeated for several iterations until the parameters do not change anymore. This process is repeated for various combinations of hyperparameters, and the model with the smallest label prediction error is selected as the final model.

When a new model (e.g., the prepared prediction MLM 112, the optional prepared event detection MLM 114, and the monitoring MLM 116) is created, and a new process for filtering and automated labeling is established, it is added to the MLM database 136 in the MLM training module 118. This enables the new model to be part of the closed-loop model update process. Optionally, at regular intervals, data which is continuously collected can be filtered, labeled, and used to update old models by an optional filtering machine learning module 229. In some examples, the optional filtering machine learning module 229 is a neural network. In some examples, the optional filtering machine learning module 229 is a mathematical model. This approach may capture changes in the data over time.

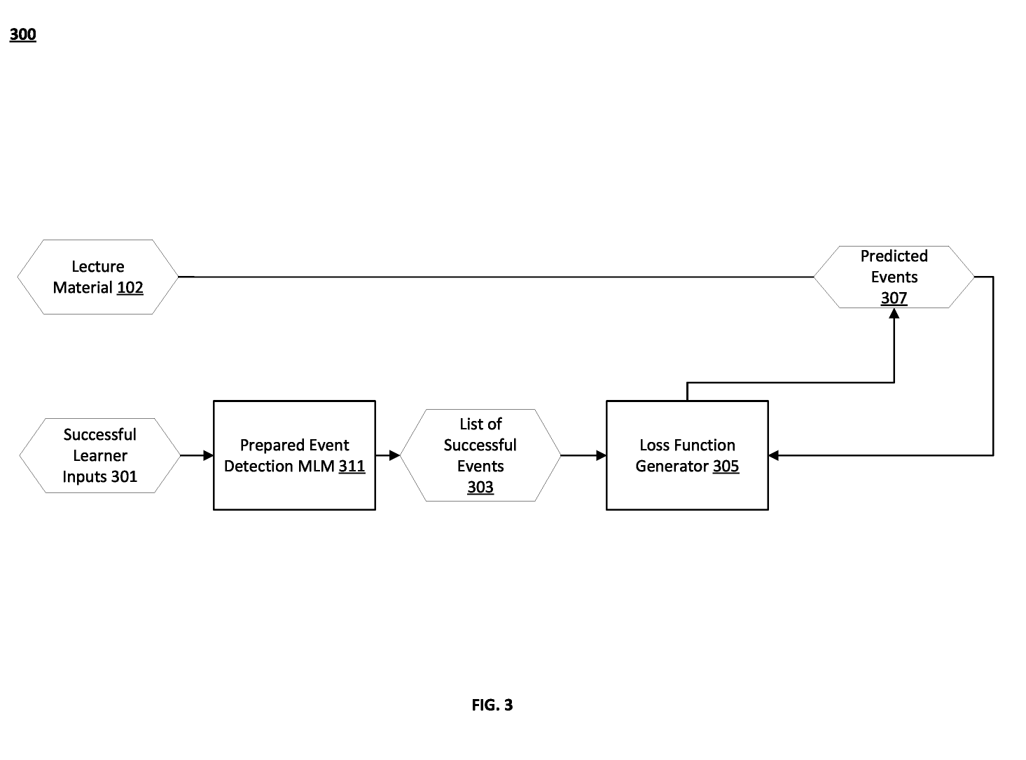

FIG. 3 is an example flowchart for preparing a MLM to predict events involved in a completing an activity according to aspects of the present disclosure. In various implementations, the method 300 is performed by a device with one or more processors and non-transitory memory that performs intent prediction. In some implementations, the method 300 is performed by processing logic, including hardware, firmware, software, or a combination thereof. In some implementations, the method 300 is performed by a processor executing code stored in a non-transitory computer-readable medium (e.g., a memory). The method 300 describes a method for training a MLM to predict events indicative of success for a shared activity by learners in a breakout room.

Breakout rooms can be utilized for a variety of engaging and interactive activities that foster collaboration and enhance participation. Discussion-based activities such as guided discussions, case studies, and debates encourage participants to share insights and perspectives on specific topics. Collaborative activities like brainstorming sessions, group projects, and mind mapping allow participants to work together creatively, often using tools like shared virtual whiteboards or documents. Problem-solving tasks, including puzzles, scenario planning, and role-playing, challenge participants to think critically and develop practical solutions.

Breakout rooms may host a wide range of activities to engage participants and promote activities. For example, a type of activity in a breakout room may include a type of problem (e.g., math, science, etc.) to be solved, a type of discussion to be discussed (e.g., literary, philosophical, business), collaborative projects (e.g., case study analysis, project planning, or collaborative writing), or creative activities (e.g., building a story together, creating a visual representation of a concept or idea, acting out a scene, etc.).

The method 300 begins preparing a prediction MLM 309 (e.g., the prediction MLM 112 from FIGS. 1-2) to predict events indicative of success for an activity (or type of activity) to be performed by learners in a breakout room by using lecture materials 102 as an input. The lecture materials 102 typically outline the activity (or activity type) to be undertaken by breakout rooms, along with the expected result, outcomes, goals, or objectives. By analyzing this structured input, the prepared prediction MLM 309 identifies patterns and features associated with successful learner engagement, activity, and goal achievement. The system then uses these insights to predict potential success indicators, such as collaboration quality, learning outcomes, or alignment with objectives, enabling facilitators to adapt and optimize the activity for improved effectiveness.

The method 300 may also utilize successful learner inputs 301 (e.g., video stream data, corresponding audio stream data, and screen captures from devices for respective learners who successfully completed the activity) to further refine the prediction MLM 309 using a loss function generator 305. Specifically, a prepared event detection MLM 311 (e.g., the optional prepared event detection MLM 114 from FIGS. 1-2) is designed to process the successful learner inputs 301 and analyze the video, audio, and screen capture data. Though this analysis, the prepared event detection MLM 311 generates a list of successful events 303, which can then inform the training process. By leveraging these insights, the system enhances the accuracy and effectiveness of the prediction MLM 309, enabling it to better predict and replicate the factors contributing to successful outcomes.

Generally, a loss function generator 305 is a tool designed to streamline and enhance the process of creating loss functions for training the prediction MLM 309. Loss functions are critical as they quantify the difference between the prediction MLM’s 309’s prediction (e.g., predicted events 307) and the actual data (e.g., list of successful events 303 derived from successful learner inputs 301) to guide the optimization process. The loss function generator 305 simplifies this task by automating the creation of mathematically consistent and customizable loss functions, reducing the likelihood of errors and saving time. It enables quick adaption to specific tasks, such as handling imbalanced data, multi-objective optimization, or domain-specific challenges. By facilitating experimentation and supporting dynamic or composite loss formulations, a loss function generator 305 efficiently while addressing diverse requirements across various applications.

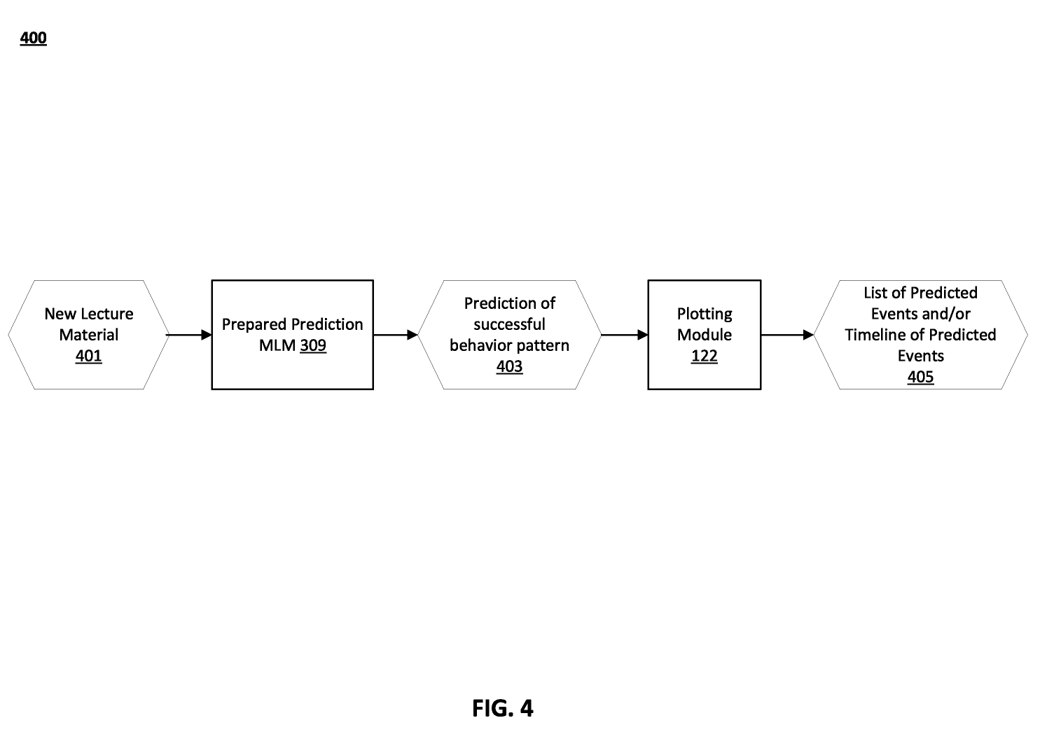

FIG. 4 is an example flowchart for preparing a MLM to predict successful behavior pattern according to aspects of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 400 is performed by a processor executing code stored in a non-transitory computer-readable medium (e.g., a memory). The method 400 describes a method for utilizing the prepared prediction MLM 309 (e.g., the prediction MLM 112 from FIGS. 1-2) to predict events that are part of successful behavior patterns on unknown (e.g., new) lecture materials.

The method 400 begins by inputting new lecture material 401 into a prepared prediction MLM 309 to predict successful behavior pattern 403. The prediction MLM 309 processes this information to predict successful behavior patterns 403 or events likely to be exhibited by learners engaging in the breakout room activity. By analyzing how learners are expected to respond, interact, and engage with each other in the breakout room while performing the activity and its structure, the model provides insights into its potential effectiveness and alignment with desired learning outcomes. This predictive capability is significant as it allows administrators to monitor breakout room activities based on data-driven insights, ensuring they foster engagement, collaboration, and learning success.

The method 400 then generates a list of predicted events and/or timeline of predicted events 405 via the optional plotting module 122 (e.g., the optional plotting module 122 from FIG. 1) using the prediction of successful behavior pattern 403. The optional plotting module 122 organizes the predicted behaviors into a structured format, such as a sequential timeline or categorized list, to provide a clear visualization of how learners are expected to interact with the material and activities over time. This step is significant because it translates abstract behavioral predictions into actionable insights, enabling administrators or facilitators to anticipate key moments during the learning process. By mapping out these events, the method 400 generates benchmarks and supports proactive planning and real-time adjustments to enhance learner engagement and ensure alignment with educational goals. Additionally, it offers a valuable tool for assessing the feasibility and impact of instructional strategies before they are implemented.

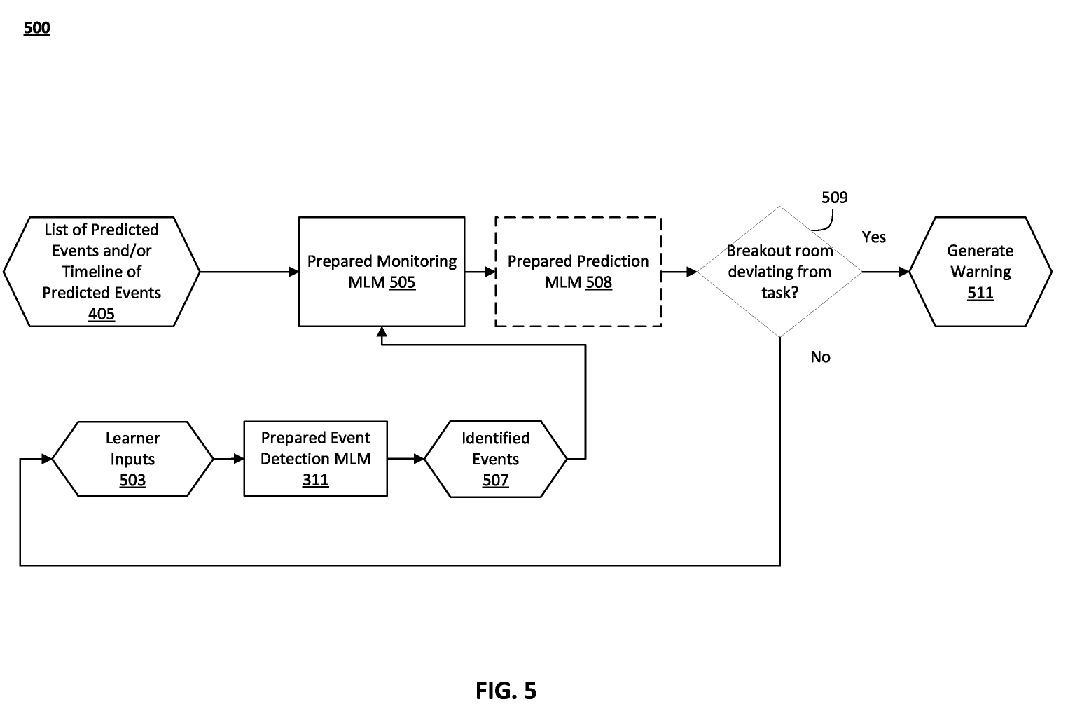

FIG. 5 is an example flowchart for utilizing a MLM to monitor learners in a breakout room according to aspects of the present disclosure. In various implementations, the method 500 is performed by a device with one or more processors and non-transitory memory that performs intent prediction. In some implementations, the method 500 is performed by processing logic, including hardware, firmware, software, or a combination thereof. In some implementations, the method 500 is performed by a processor executing code stored in a non-transitory computer-readable medium (e.g., a memory). The method 500 describes a method for utilizing the prepared monitoring MLM 505 (e.g., the monitoring MLM 116 from FIGS. 1-2) to monitor learners in a breakout room and alert a user when the learners are deviating from a list of predicted events.

The method 500 may begin with inputting the list of predicted events and/or timeline of predicted events 405 (e.g., list of predicted events and/or timeline of predicted events 405 from FIG. 4) into the prepared monitoring MLM 505 (e.g., the monitoring MLM 116 from FIGS. 1-2) in order to generate a pattern of successful behavior from learners who successfully complete a task. This process enables the prepared monitoring MLM 505 to analyze sequences of predicted events, identifying and generating patterns of successful behavior exhibited by learners who have effectively completed specific tasks. The significance of this approach lies in its ability to leverage data-driven insights to discern key behavioral trends and success indicators, ultimately enhancing predictive accuracy and informing the development of targeted interventions to support learner achievement.

The method 500 then obtains the learner inputs 503 (e.g., data streams from the cameras 109a, 109b, 109n, audio streams from the microphones 113a, 113b, 113n, and screen captures of the computing devices 111a, 111b, 111n to monitor the learners 107a, 107b, 107n in the breakout rooms from FIG. 1) while the learners are engaged in a group activity in breakout rooms and inputs the learner inputs 503 into a prepared event detection MLM 311 (e.g., the optional prepared event detection MLM 114 from FIGS. 1-2). The prepared event detection MLM 311 is prepared to identify the events 507 from the learner inputs 503 based at least in part on tracking a person in a sequence of frames of video streams. In particular, the prepared event detection MLM 311 is trained to generate predicted events 507 using an events training set comprising of a sequence of frames containing an action performed by a person and an event label identifying the action in the sequence of frames of the video.

The identified events 507 are then input into the prepared monitoring MLM 505 to evaluate whether the identified events 507 correspond to the list of predicted events and/or timeline of predicted events 405. The idea is that if the identified events 507 match the list of predicted events and/or timeline of predicted events 405, then the prepared monitoring MLM 505 may determine that the breakout room is deviating from the assigned task 509 and a warning should be generated 511. Conversely, if the identified events 507 align with the list of predicted events and/or timeline of predicted events 405, the system continues monitoring learning inputs 503 using the prepared event detection MLM 311. This process is significant because it ensures that learning activities stay on track, promptly identifying and addressing off-task behavior to maintain productivity and enhance learning outcomes.

In some aspects, the identified events 507 are further input into a prepared prediction MLM 508 (e.g., prediction MLM 112 shown in FIGS. 1-2) to determine whether the breakout room is deviating from the assigned task 508. This method leverages MLMs to enhance group activities in breakout rooms by analyzing learner interactions to identify successful behavior patterns. A pre-trained prediction MLM assesses indicators of success based on lecture material, activity type, and prior results, while a monitoring MLM tracks group dynamics, detecting deviations from the task. If deviations occur, alerts notify facilitators for timely intervention, ensuring focused, productive collaboration.

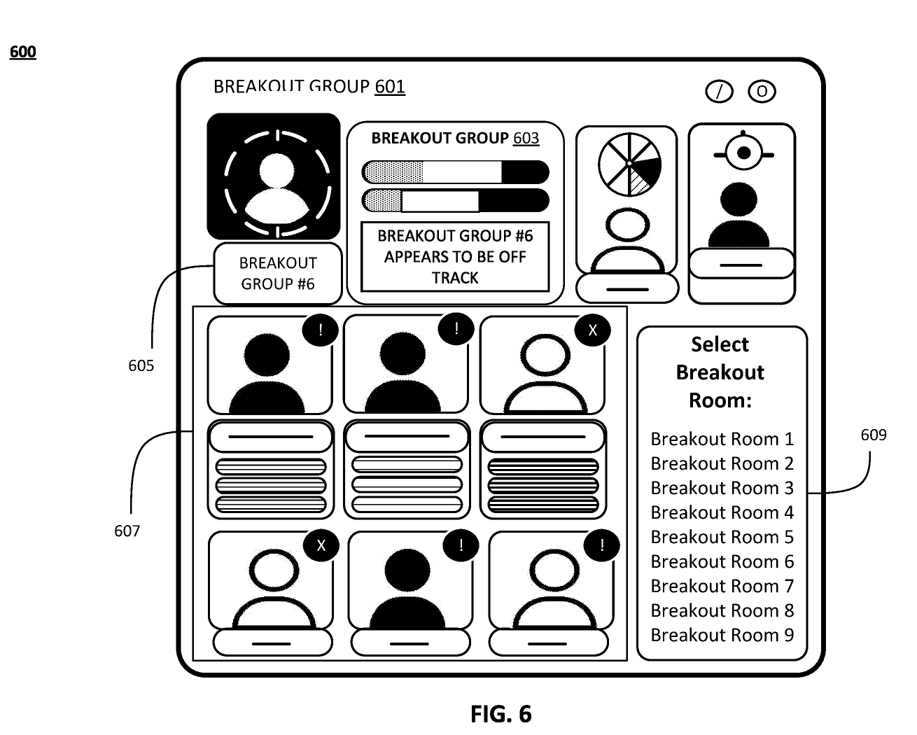

FIG. 6 an example of a UI 601 for monitoring learners in a breakout room including generating alerts when learners are predicted to be off track according to aspects of the present disclosure. In this way, predicting whether a breakout room is deviating from the assigned task is further based on outputs of the prepared monitoring MLM and the prepared MLM. This method leverages MLMs to enhance group activities in breakout rooms by analyzing learner interactions to identify successful behavior patterns. A pre-trained prediction MLM assesses indicators of success based on lecture material, activity type, and prior results, while a monitoring MLM tracks group dynamics, detecting deviations from the task. If deviations occur, alerts notify facilitators for timely intervention, ensuring focused, productive collaboration. This data-driven approach optimizes group interactions, improving engagement and learning outcomes..

As shown in example 600, the UI 601 includes a real-time breakout group monitoring panel 607 that shows at least learners in a particular breakout group 605, and an alert 603 generated when it is predicted that the learners in the breakout room are deviating from the assigned task. In some aspects, the real-time breakout group monitoring panel 607 may show the video streams of each learner in the breakout room and a selection panel 609 for a facilitator to select a breakout room to join and/or view.

It will be understood by those skilled in the art that the specific UI elements and layout in the UI 601 is not limited to example 600. The technical solution according to the present disclosure may include more or fewer panels and/or UI elements.

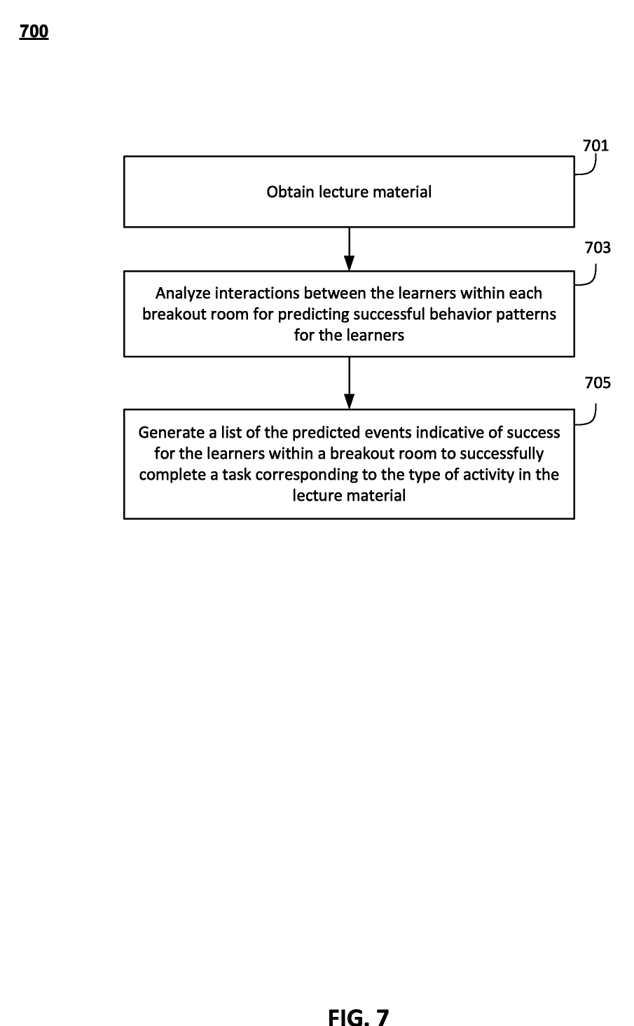

FIG. 7 is an example method for preparing a MLM to predict events involved in a completing an activity according to aspects of the present disclosure. In various implementations, the method 700 is performed by a device with one or more processors and non-transitory memory that performs intent prediction. In some implementations, the method 700 is performed by processing logic, including hardware, firmware, software, or a combination thereof. In some implementations, the method 700 is performed by a processor executing code stored in a non-transitory computer-readable medium (e.g., a memory). The method 700 describes a method for training a MLM to predict events indicative of success performed by learners in a breakout room.

At 701, the method 700 may include obtaining lecture material comprising at least a type of activity to be performed in the breakout rooms by groups of learners and an expected result of the type of activity. In some aspects, the the result corresponds to text, pictures, or numerical answers.

In some aspects, the breakout rooms correspond to virtual breakout rooms.

In some aspects, the method may include determining the type of activity based on the lecture material using a Large Language Model (LLM). The LLM may analyze the content of the lecture material to identify key concepts, instructional goals, and contextual cues, allowing it to classify the activity type—such as a discussion, problem-solving task, or collaborative project. This classification helps tailor monitoring and support strategies to the specific nature of the activity.

At 703, the method 700 may include analyzing interactions between the learners within a group of each breakout room for predicting successful behavior patterns for the type of activity using a prepared prediction MLM configured to predict events indicative of success for the type of activity based on the obtained lecture material, the type of activity, and the result. In some aspects, the prepared MLM comprises one or more of: a classification model, a regression classification model, an autoencoder neural network, a neural network model, or an LLM.

In some aspects, the type of activity comprises at least a type of task to be solved and a type of discussion for solving the task. This dual classification allows the system to distinguish not only the nature of the assigned activity —such as analytical, creative, or procedural—but also the interaction style needed for effective problem-solving by the learners, whether it be collaborative brainstorming, structured debate, or guided inquiry.

In some aspects, the method 700 may include preparing the prediction MLM by: (1) providing, to the prediction MLM, a prediction training dataset comprising at least one of: (a) a plurality of training lecture material data comprising at least lecture material, a type of activity to be performed and the expected result of the type of activity, wherein the plurality of training lecture material data is labeled and annotated to identify a type of activity; (b) interaction data annotated and labeled to assess communication features, collaboration metrics, or emotional and sentiment features; (c) activity data annotated and labeled to classify the types of activities performed in breakout rooms and associate activity types with specific lecture topics or objectives; (d) performance and outcome data annotated and labeled with outcome metrics and success indicators; and (e) ground truth labels for the plurality of training lecture material data, the interaction data, the activity data, or the performance and outcome data to serve as a target output for the prediction MLM model, wherein the ground truth labels comprise at least success labels identifying successful and unsuccessful behavior patterns in the breakout rooms, behavior patterns identifying specific behaviors, or event labels identifying events indicative of success or failure; and (2) preparing the prediction MLM using the prediction training dataset.

In some aspects, the method 700 may include preparing the prediction MLM by: obtaining, for each breakout room that successfully performed an assigned task for the type of activity in the breakout room, a plurality of video streams capturing each respective learner, a plurality of audio streams for each respective learner, and a plurality of capture streams capturing an interaction of each learner and a respective computing device; identifying events from the plurality of video streams, the plurality of audio streams, and the plurality of capture streams; generating a list of events indicating success based on the identified events; computing a loss value by measuring a delta between the generated list of the predicted events and the identified events indicative of success; and adjusting one or more parameters of the prediction MLM based on the computed loss value.

In some aspects, the method 700 may include executing a prepared event detection MLM to identify the events from the plurality of video streams based at least in part on tracking a person in a sequence of frames of the video streams, wherein the prepared event detection MLM is trained to identify people and in a video using an events training set comprising of a sequence of frames containing an action performed by a person and an event label identifying the action in the sequence of frames of the video.

At 705, the method 700 may include generating a list of the predicted events indicative of success for a group of learners within a breakout room to successfully complete a task corresponding to the type of activity in the lecture material. In this way, the system can create a data-driven framework for monitoring learner progress. Thus, by establishing clear indicators of success, the system can more effectively track group performance, identify deviations from productive learner behavior, and provide timely interventions when learners are predicted to stray off track.

Optionally, in some aspects, the method 700 may include plotting the predicted events on a timeline and displaying, on a display, the timeline. This process involves mapping key events indicative of successful task completion in chronological order, providing a clear, structured view of expected learning milestones. Displaying the timeline allows educators or monitoring systems to easily track the progression of learner activities against the predicted sequence, quickly identifying any deviations or gaps.

In some aspects, the predicted events correspond to at least one of engagement events, task accomplishment events, and deviation events. Engagement events indicate active learner participation, task accomplishment events reflect progress toward or completion of specific learning objectives, and deviation events signal behaviors that diverge from the intended learning path. By categorizing predicted events in this way, the system can provide a comprehensive view of the progress of the learners in their assigned task, enabling more precise monitoring and timely interventions.

As a non-limiting example, the engagement events and/or deviation events may include at least one of: silence longer than a predefined time period, learners taking turns speaking, assigning roles, collaboratively editing a share file, requesting clarification from instructor, responding to queries from the instructor, using a chat feature, repeating ideas, sequential collaboration, focused eye contact, gestures to signal speaking, and use of visual cues.

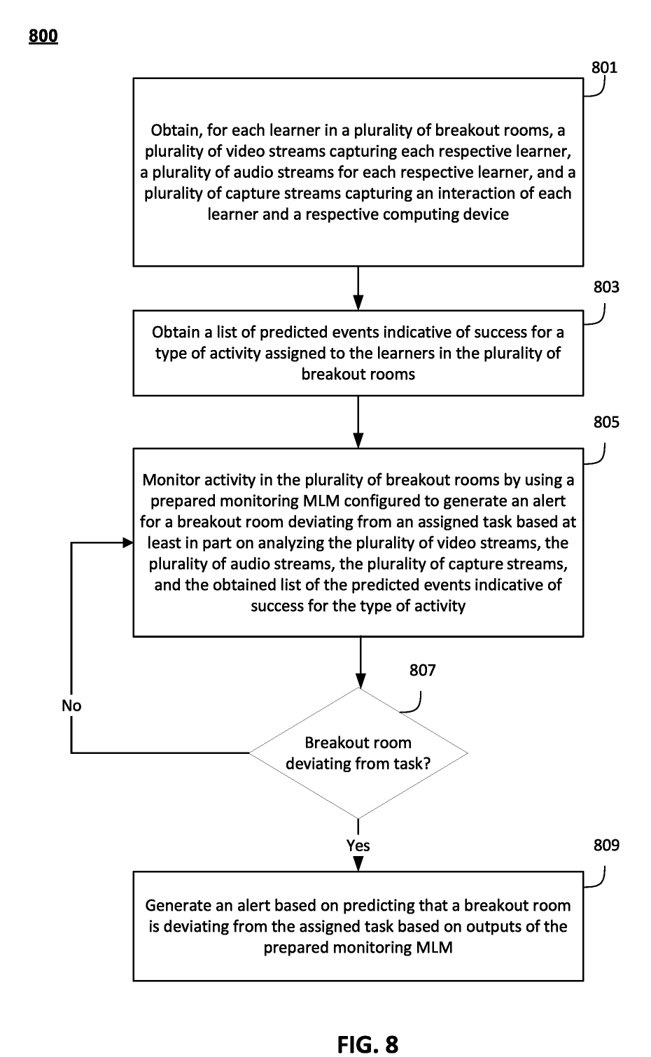

FIG. 8 is an example flowchart for utilizing a MLM to monitor learners in a breakout room according to aspects of the present disclosure. In various implementations, the method 800 is performed by a device with one or more processors and non-transitory memory that performs intent prediction. In some implementations, the method 800 is performed by processing logic, including hardware, firmware, software, or a combination thereof. In some implementations, the method 800 is performed by a processor executing code stored in a non-transitory computer-readable medium (e.g., a memory). The method 800 describes a method for monitoring lecturer behavior in breakout rooms.

At 801, the method 800 may include obtaining, for each learner in a plurality of breakout rooms, a plurality of video streams capturing each respective learner, a plurality of audio streams for each respective learner, and a plurality of capture streams capturing an interaction of each learner and a respective computing device. This data collection provides the system with a multi-dimensional view of learner behavior, capturing both verbal and non-verbal cues, as well as digital interactions.

At 803, the method 800 may include obtaining a list of predicted events indicative of success for a type of activity assigned to the learners in the plurality of breakout rooms. In some aspects, the predicted events may correspond to at least one of: engagement events, task accomplishment events, and deviation events. In some aspects, the type of activity comprises at least a type of task to be solved and a type of discussion for solving the task.

At 805, the method 800 may include monitoring activity in the plurality of breakout rooms by using a prepared monitoring MLM configured to generate an alert for a breakout room deviating from an assigned task based at least in part on analyzing the plurality of video streams, the plurality of audio streams, the plurality of capture streams, and the obtained list of the predicted events indicative of success for the type of activity.

In some aspects, the method 800 may include obtaining the list of predicted events indicative of success for the type of activity on a timeline; and monitoring the activity in the plurality of breakout rooms by using the prepared monitoring MLM configured to generate the alert for a breakout room deviating from the type of activity based at least in part on analyzing the plurality of video streams, the plurality of audio streams, the plurality of capture streams, the obtained list of the predicted events indicative of success for the type of activity, and the timeline.

In some aspects, the method 800 may include obtaining lecture material corresponding to the plurality of breakout rooms and an expected result of the type of activity; and determining the type of activity based on the lecture material using a Large Language Model (LLM). In some aspects, the expected result may correspond to text, pictures, or numerical answers.

At 807, the method 800 may include determining whether learners in a breakout room are deviating from the task. This process works by leveraging machine learning to detect patterns in learner behavior and interactions, comparing them against the expected events that signify productive task engagement.

Based on a determination that the learners in the breakout room are deviating from the task, at 809, the method 800 may include generating an alert based on predicting that a breakout room is deviating from the assigned task based on outputs of the prepared monitoring MLM.

Based on a determination that the learners in the breakout room at not deviating from the task, then the method 800 returns to step 805.

In some aspects, the method 800 may further include analyzing interactions between the learners within a group of each breakout room for predicting successful behavior patterns for the type of activity using a prepared prediction machine learning model (MLM) configured to predict events indicative of success for the type of activity based on the obtained lecture material, the type of activity, and the result; and generating the alert based on predicting that a breakout room is deviating from the assigned task based on outputs of the prepared monitoring MLM and the prepared MLM. The described method utilizes MLMs to enhance the effectiveness of group activities in breakout rooms. Specifically, it involves analyzing learner interactions within each group to identify successful behavior patterns for a given activity. A pre-trained prediction MLM is employed to assess events indicative of success by considering factors such as the obtained lecture material, the type of activity, and prior results. Additionally, a monitoring MLM continuously evaluates group dynamics and detects deviations from the assigned task. If such deviations are predicted, an alert is generated to notify facilitators, allowing for timely intervention. This approach ensures that collaborative learning remains focused and productive, improving engagement and overall learning outcomes by leveraging data-driven insights to optimize group interactions.

FIG. 9 presents an example of a general-purpose computer system on which aspects of the present disclosure can be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-8 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 maybe local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for machine-learning (ML)-based monitoring of learners in breakout rooms, further comprising:
obtaining, for each learner in a plurality of breakout rooms, a plurality of video streams capturing each respective learner, a plurality of audio streams for each respective learner, and a plurality of capture streams capturing an interaction of each learner and a respective computing device;
obtaining a list of predicted events indicative of success for a type of activity assigned to the learners in the plurality of breakout rooms;
monitoring activity in the plurality of breakout rooms by using a prepared monitoring MLM configured to generate an alert for a breakout room deviating from an assigned task based at least in part on analyzing the plurality of video streams, the plurality of audio streams, the plurality of capture streams, and the obtained list of the predicted events indicative of success for the type of activity; and
generating an alert based on predicting that a breakout room is deviating from the assigned task based on outputs of the prepared monitoring MLM.

2. The method of claim 1, further comprising:
obtaining the list of predicted events indicative of success for the type of activity on a timeline; and
monitoring the activity in the plurality of breakout rooms by using the prepared monitoring MLM configured to generate the alert for a breakout room deviating from the type of activity based at least in part on analyzing the plurality of video streams, the plurality of audio streams, the plurality of capture streams, the obtained list of the predicted events indicative of success for the type of activity, and the timeline.

3. The method of claim 1, wherein the predicted events correspond to at least one of: engagement events, task accomplishment events, and deviation events.

4. The method of claim 1, wherein the type of activity comprises at least a type of task to be solved and a type of discussion for solving the task.

5. The method of claim 1, further comprising:
obtaining lecture material corresponding to the plurality of breakout rooms and an expected result of the type of activity; and
determining the type of activity based on the lecture material using a Large Language Model (LLM).

6. The method of claim 5, wherein the expected result corresponds to text, pictures, or numerical answers.

7. The method of claim 1, further comprising preparing the monitoring MLM by:
(1) providing, to the monitoring MLM, a monitoring training dataset comprising at least one of:
(a) a plurality of training video stream data labeled and annotated to identify task engagement features and task deviation features,
(b) a plurality of training audio stream data labeled and annotated to identify task-oriented speech and off-task speech,
(c) capture stream data labeled and annotated to identify on-task activity and off-task activity, and
(d) ground truth labels for the plurality of training video stream data, the plurality of training audio stream data, or the capture stream data to serve as a target output for the monitoring MLM; and
(2) preparing the monitoring MLM using the monitoring training dataset.

8. The method of claim 1, wherein the prepared monitoring MLM comprises one or more of: a classification model, a regression classification model, an autoencoder neural network, a neural network model, or an LLM.

9. The method of claim 1, wherein the breakout rooms correspond to virtual breakout rooms.

10. The method of claim 1, further comprising:
analyzing interactions between the learners within a group of each breakout room for predicting successful behavior patterns for the type of activity using a prepared prediction MLM configured to predict events indicative of success for the type of activity based on the obtained lecture material, the type of activity, and the result; and
generating the alert based on predicting that a breakout room is deviating from the assigned task based on outputs of the prepared monitoring MLM and the prepared MLM.

11. A system for machine-learning (ML)-based monitoring of learners in breakout rooms, comprising:
at least one memory; and
at least one hardware processor coupled with the at least one memory and configured, individually or in combination, to:
obtain, for each learner in a plurality of breakout rooms, a plurality of video streams capturing each respective learner, a plurality of audio streams for each respective learner, and a plurality of capture streams capturing an interaction of each learner and a respective computing device;
obtain a list of predicted events indicative of success for a type of activity assigned to the learners in the plurality of breakout rooms;
monitor activity in the plurality of breakout rooms by using a prepared monitoring MLM configured to generate an alert for a breakout room deviating from an assigned task based at least in part on analyzing the plurality of video streams, the plurality of audio streams, the plurality of capture streams, and the obtained list of the predicted events indicative of success for the type of activity; and
generate an alert based on predicting that a breakout room is deviating from the assigned task based on outputs of the prepared monitoring MLM.

12. The system of claim 11, wherein the at least one hardware processor is further coupled with the at least one memory and configured, individually or in combination, to:
obtain the list of predicted events indicative of success for the type of activity on a timeline; and
monitor the activity in the plurality of breakout rooms by using the prepared monitoring MLM configured to generate the alert for a breakout room deviating from the type of activity based at least in part on analyzing the plurality of video streams, the plurality of audio streams, the plurality of capture streams, the obtained list of the predicted events indicative of success for the type of activity, and the timeline.

13. The system of claim 11, wherein the predicted events correspond to at least one of: engagement events, task accomplishment events, and deviation events.

14. The system of claim 11, wherein the type of activity comprises at least a type of task to be solved and a type of discussion for solving the task.

15. The system of claim 12, wherein the at least one hardware processor is further coupled with the at least one memory and configured, individually or in combination, to:
obtain lecture material corresponding to the plurality of breakout rooms and an expected result of the type of activity; and
determine the type of activity based on the lecture material using a Large Language Model (LLM).

16. The system of claim 15, wherein the expected result corresponds to text, pictures, or numerical answers.

17. The system of claim 11, wherein the at least one hardware processor is further coupled with the at least one memory and configured, individually or in combination, to: prepare the monitoring MLM by:
(1) providing, to the monitoring MLM, a monitoring training dataset comprising at least one of:
(a) a plurality of training video stream data labeled and annotated to identify task engagement features and task deviation features;
(b) a plurality of training audio stream data labeled and annotated to identify task-oriented speech and off-task speech;
(c) capture stream data labeled and annotated to identify on-task activity and off-task activity;
(d) ground truth labels for the plurality of training video stream data, the plurality of training audio stream data, or the capture stream data to serve as a target output for the monitoring MLM; and
(2) preparing the monitoring MLM using the monitoring training dataset.

18. The system of claim 11, wherein the prepared monitoring MLM comprises one or more of: a classification model, a regression classification model, an autoencoder neural network, a neural network model, or an LLM.

19. A non-transitory computer readable medium storing thereon computer executable instructions for machine-learning (ML)-based monitoring of learners in breakout rooms, including instructions for:
obtaining, for each learner in a plurality of breakout rooms, a plurality of video streams capturing each respective learner, a plurality of audio streams for each respective learner, and a plurality of capture streams capturing an interaction of each learner and a respective computing device;
obtaining a list of predicted events indicative of success for a type of activity assigned to the learners in the plurality of breakout rooms;
monitoring activity in the plurality of breakout rooms by using a prepared monitoring MLM configured to generate an alert for a breakout room deviating from an assigned task based at least in part on analyzing the plurality of video streams, the plurality of audio streams, the plurality of capture streams, and the obtained list of the predicted events indicative of success for the type of activity; and
generating an alert based on predicting that a breakout room is deviating from the assigned task based on outputs of the prepared monitoring MLM.

20. The non-transitory computer readable medium of claim 19, further including instructions for:
obtaining the list of predicted events indicative of success for the type of activity on a timeline; and
monitoring the activity in the plurality of breakout rooms by using the prepared monitoring MLM configured to generate the alert for a breakout room deviating from the type of activity based at least in part on analyzing the plurality of video streams, the plurality of audio streams, the plurality of capture streams, the obtained list of the predicted events indicative of success for the type of activity, and the timeline.
